(19) United States
(12) Patent Application Publication
(10) Pub. No.: US 2008/0038089 A1
(43) Pub. Date: Feb. 14, 2008

(54) Screw with two threads having different orientations

(76) Inventor: Teng-Hung Lin, Kaohsiung Hsien (TW)

Correspondence Address: TENG-HUNG LIN, 235 Chung - Ho, Box 8-24, Taipei, omitted

(21) Appl. No.: 11/481,680

(22) Filed: Jul. 7, 2006

(51) Int. Cl. F16B 35/04

(52) U.S. Cl. 411/412

(57) ABSTRACT

A screw with two threads having different orientations is disclosed. The screw having a flat surface at a bottom side of the screw head; an annular recess being formed in the flat surface and around the screw rod; an upper thread formed at an upper portion of the screw rod; and a lower thread connected to the upper thread and formed on a lower portion of the screw rod and the tapered portion; a thread pitch of the lower thread being equal to that of the upper thread; an outer diameter of the lower thread on the screw rod being equal to that of the upper thread. Furthermore, each of upper thread and lower thread has a triangular cross section; and the slope angle of an upper side of each of the upper thread and lower thread is greater than that of the lower side of the respective one of the upper thread and lower thread.

### FIELD OF THE INVENTION

The present invention relates to screws, and in particular to a screw with two threads having different orientations, a bottom side of the screw head is formed as a flat surface; an annular recess being formed in the flat surface and around the screw rod; an upper thread formed at an upper portion of the screw rod; and a lower thread connected to the upper thread and formed on a lower portion of the screw rod and the tapered portion; a thread pitch of the lower thread being equal to that of the upper thread; an outer diameter of the lower thread on the screw rod being equal to that of the upper thread. Furthermore, each of upper thread and lower thread has a triangular cross section; the slope angle of an upper side of each of the upper thread and lower thread is greater than that of the lower side of the respective one of the upper thread and lower thread.

### BACKGROUND OF THE INVENTION

The design principle of screws is to make the screw be screwed into an object rapidly, power-saved, and firmly fastened. In the prior art two threads screws, the upper thread is not connected to the lower thread. That is, a section without thread is formed between the upper thread and the lower thread. Furthermore, an outer diameter of the upper thread is greater than a lower diameter of the lower thread and the screw rod is formed with at least two stages which have different diameters. Furthermore, the lower thread does not extend to the tip end of the tapered portion of the screw. However the prior art is not convenient in operation. The dregs can not be removed effectively and the screw cannot be firmly secured.

### SUMMARY OF THE INVENTION

Accordingly, the primary object of the present invention is to provide a screw with two threads having different orientations. The screw comprises a screw rod having a single diameter; the screw rod having two ends at two opposite sides of the screw rod; a tapered portion formed at one end of the screw rod; a screw head formed at another end of the screw rod; a bottom side of the screw head being formed as a flat surface; an annular recess being formed in the flat surface and around the screw rod; an upper thread formed at an upper portion of the screw rod; and a lower thread connected to the upper thread and formed on a lower portion of the screw rod and the tapered portion; a thread pitch of the lower thread being equal to that of the upper thread; an outer diameter of the lower thread on the screw rod being equal to that of the upper thread. One distal end of the lower thread is extended to a tip end of the tapered portion or is extended to be over a tip end of the tapered portion. Each of upper thread and lower thread has a triangular cross section; the slope angle of an upper side of each of the upper thread and lower thread is greater than that of the lower side of the respective one of the upper thread and lower thread. Moreover, a plurality of strips are formed on the flat surface and at an outer side of the annular recess.

The various objects and advantages of the present invention will be more readily understood from the following detailed description when read in conjunction with the appended drawing.

### BRIEF DESCRIPTION OF THE DRAWINGS

FIG. 1 shows the first embodiment of the present invention.

FIG. 2 is an enlarged view of the A area of FIG. 1.

FIG. 3 is an enlarged view of the B area of FIG. 1.

FIG. 4 is a cross sectional view of the first embodiment of the present invention.

FIG. 5 is an elevational view of the first embodiment of the present invention.

FIG. 6 is a cross sectional view of the second embodiment of the present invention.

FIG. 7 is an elevational view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

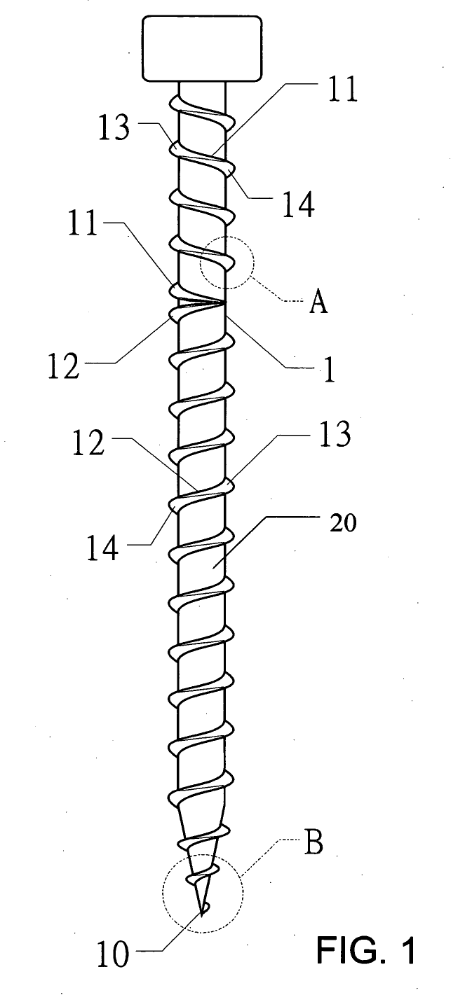

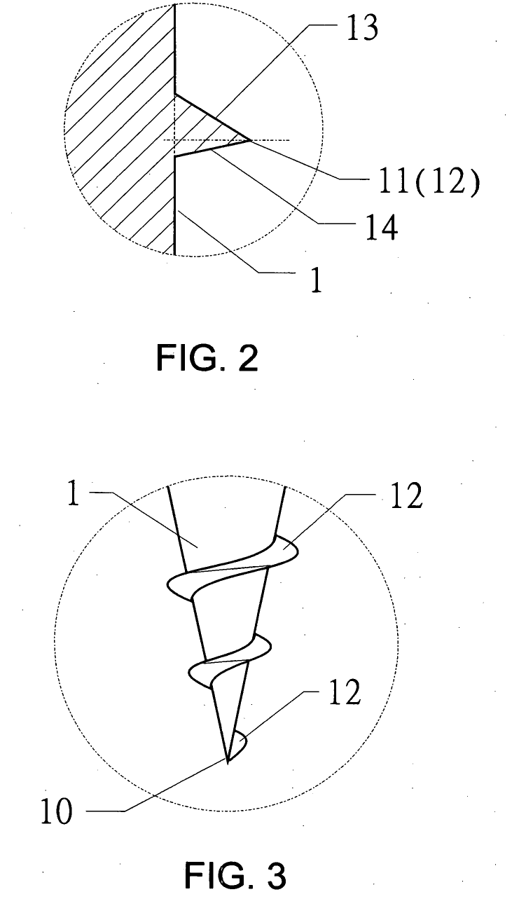

Referring to FIGS. 1 to 5, the screw of the present invention is illustrated. The present invention has the following elements.

A screw rod 20 has a single diameter. The screw rod 20 has two ends at two opposite sides of the screw rod 20.

A tapered portion 10 is formed at one end of the screw rod 1.

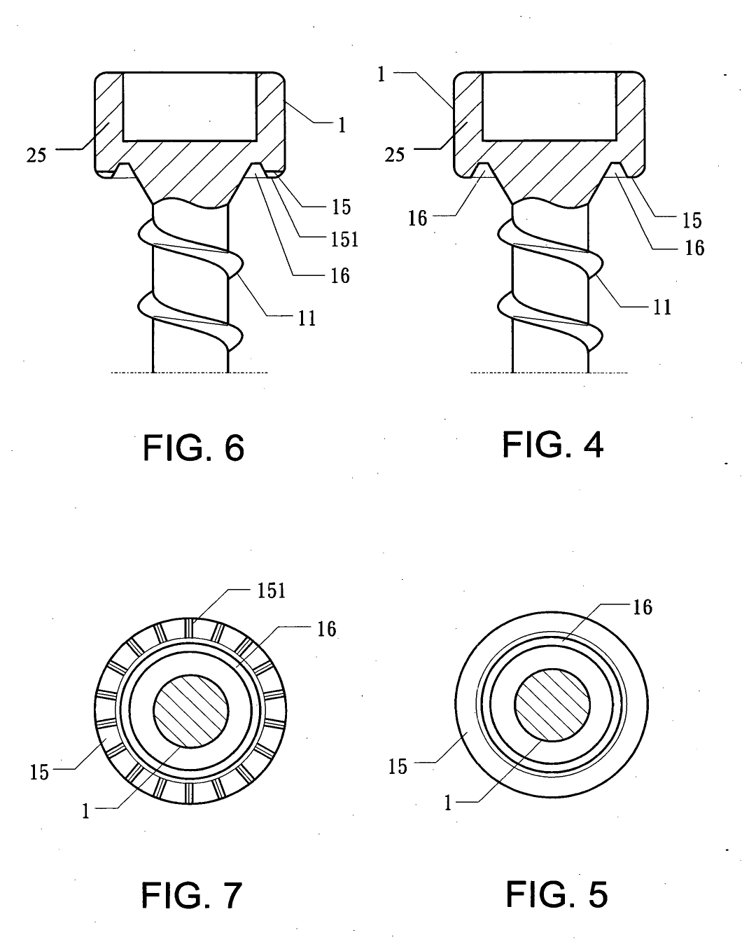

A screw head 25 is formed at another end of the screw rod 20. A bottom side of the screw head 25 is formed as a flat surface 15. The flat surface 15 can be flatly adhered to a screwed object, as shown in FIGS. 4 and 5. An annular recess 16 is formed in the flat surface 15 and around the screw rod 20. The dregs from screwing operation can be received in the annular recess 16.

An upper thread 11 is formed at an upper portion of the screw rod 1

A lower thread 12 is connected to the upper thread 11 and is formed on the lower portion of the screw rod 1 and the tapered portion 10. The thread pitch of the lower thread 12 is equal to that of the upper thread 11. An outer diameter of the lower thread 12 on the screw rod 1 is equal to that of the upper thread 11. One distal end of the lower thread 12 is extended to a tip end of the tapered portion 10, even over the tip end of the tapered portion 10.

Each of upper thread 11 and lower thread 12 has a triangular cross section. The slope angle of an upper side 13 of each of the upper thread 11 and lower thread 12 is greater than that of the lower side 14 of the respective one of the upper thread 11 and lower thread 12.

By above mentioned structure, the dregs in screwing operation will be driven from the lower thread 12 to the upper thread 11 continuously since the upper thread 11 is connected to the lower thread 12.

Referring to FIGS. 6 and 7, another embodiment of the present invention is illustrated. A plurality of strips are formed on the flat surface 15 and at an outer side of the annular recess 16 so that flat surface 15 is tightly engaged to an outer surface of a screwed object.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw with two threads having different orientations; comprising:
a screw rod having a single diameter; the screw rod having two ends at two opposite sides of the screw rod;
a tapered portion formed at one end of the screw rod;
a screw head formed at another end of the screw rod; a bottom side of the screw head being formed as a flat surface; an annular recess being formed in the flat surface and around the screw rod;
an upper thread formed at an upper portion of the screw rod; and
a lower thread connected to the upper thread and formed on a lower portion of the screw rod and the tapered portion; a thread pitch of the lower thread being equal to that of the upper thread; an outer diameter of the lower thread on the screw rod being equal to that of the upper thread.

2. The screw with two threads having different orientations as claimed in claim 1, wherein one distal end of the lower thread is extended to a tip end of the tapered portion.

3. The screw with two threads having different orientations as claimed in claim 1, wherein one distal end of the lower thread is extended to be over a tip end of the tapered portion.

4. The screw with two threads having different orientations as claimed in claim 1, wherein each of upper thread and lower thread has a triangular cross section; the slope angle of an upper side of each of the upper thread and lower thread is greater than that of the lower side of the respective one of the upper thread and lower thread.

5. The screw with two threads having different orientations as claimed in claim 1, wherein a plurality of strips are formed on the flat surface and at an outer side of the annular recess.
